(19) United States
(12) Patent Application Publication
(10) Pub. No.: US 2022/0202182 A1
(43) Pub. Date: Jun. 30, 2022

(54) SLIDE RAIL AND IMAGE FORMING APPARATUS

(71) Applicant: KYOCERA Document Solutions Inc., Osaka (JP)

(72) Inventor: Akira ISHII, Osaka-shi (JP)

(73) Assignee: KYOCERA Document Solutions Inc., Osaka (JP)

(21) Appl. No.: 17/560,758

(22) Filed: Dec. 23, 2021

(30) Foreign Application Priority Data
Dec. 28, 2020 (JP) 2020-218573

(51) Int. Cl. A47B 88/483; B41J 13/10

(52) U.S. Cl. CPC A47B 88/483; A47B 2210/17; B41J 13/103

(57) ABSTRACT

A pair of slide rails supports a unit on inner side surfaces of a housing in a drawable manner. Each of the pair of slide rails includes a fixed rail, an intermediate rail, and a moving rail. The fixed rail is fixed on the inner side surface along a draw-in direction and a draw-out direction. The intermediate rail is engaged with the fixed rail in a slidable manner. The moving rail is fixed on the unit and engaged with the intermediate rail in a slidable manner. The intermediate rail includes a base part and an upper edge part and a lower edge part respectively bent inward from an upper end and a lower end of the base part. The base part has an extended part formed in such a manner that the lower edge part is protruded from a front end portion of the base part in the draw-out direction.

### INCORPORATION BY REFERENCE

This application is based on and claims the benefit of priority from Japanese patent application No. 2020-218573 filed on Dec. 28, 2020, which is incorporated by reference in its entirety.

### BACKGROUND

The present disclosure relates to an image forming apparatus including a slide rail which supports a sheet feeding cassette in a housing in a drawable manner.

In an image forming apparatus, a sheet feeding cassette in which sheets are stored may be supported in a housing by a drawing structure.

Such a drawing structure (a slide rail) includes a moving part and a guide part. The moving part is fixed on a side plate of a drawer (a sheet feeding cassette), and is slidable with the drawing out of the drawer. The guide part is fixed on an inner side wall of a cabinet (the housing), and guides the moving part. The moving part is a two-step moving rail which slides in two steps.

In the image forming apparatus, when a sheet jamming occurs or a maintenance work is performed, the sheet feeding cassette is drawn out from the housing completely and detached from the housing. In the above drawing structure, when the sheet feeding cassette is attached to the housing again, it is necessary to insert the moving part into the guide part along a direction opposite to the drawing direction. Because the sheet feeding cassette has the predetermined length in the drawing direction, it is difficult to position the moving part to the guide part from the downstream side in the drawing direction, and it becomes difficult to attach the sheet feeding cassette to the housing again.

### SUMMARY

In accordance with an aspect of the present disclosure, a pair of slide rails supports a unit on inner side surfaces of a housing in a drawable manner. Each of the pair of slide rails includes a fixed rail, an intermediate rail, and a moving rail. The fixed rail is fixed on the inner side surface of the housing along a draw-in direction and a draw-out direction opposite to the draw-in direction. The intermediate rail is engaged with the fixed rail in a slidable manner along the fixed rail. The moving rail is fixed on the unit and engaged with the intermediate rail in a slidable manner along the intermediate rail. The intermediate rail is formed to have a U-shaped cross section including a base part extending along the inner side surface of the housing and an upper edge part and a lower edge part respectively bent inward from an upper end and a lower end of the base part. The base part of the intermediate rail has an extended part formed in such a manner that the lower edge part is protruded from a front end portion of the base part in the draw-out direction.

In accordance with an aspect of the present disclosure, an image forming apparatus includes a sheet feeding cassette in which a sheet is stored; an image forming part which forms an image on the sheet fed from the sheet feeding cassette; and the pair of slide rails which supports the sheet feeding cassette on an apparatus main body in a drawable manner.

The other features and advantages of the present disclosure will become more apparent from the following description. In the detailed description, reference is made to the accompanying drawings, and preferred embodiments of the present disclosure are shown by way of example in the accompanying drawings.

### BRIEF DESCRIPTION OF THE DRAWINGS

FIG. 1 is a perspective view showing an image forming apparatus according to one embodiment of the present disclosure.

FIG. 2 is a front view schematically showing a slide rail according to the embodiment of the present disclosure.

FIG. 3 is a perspective view showing a fixed rail and an intermediate rail of the slide rail according to the embodiment of the present disclosure.

FIG. 4 is a perspective view showing the fixed rail, the intermediate rail and a moving rail of the slide rail according to the embodiment of the present disclosure.

FIG. 5 is a perspective view showing the slide rail according to the embodiment of the present disclosure, in a middle of a process in which the moving rail is engaged with the intermediate rail.

### DETAILED DESCRIPTION

Hereinafter, with reference to the attached drawings, a slide rail and an image forming apparatus according to one embodiment of the present disclosure will be described.

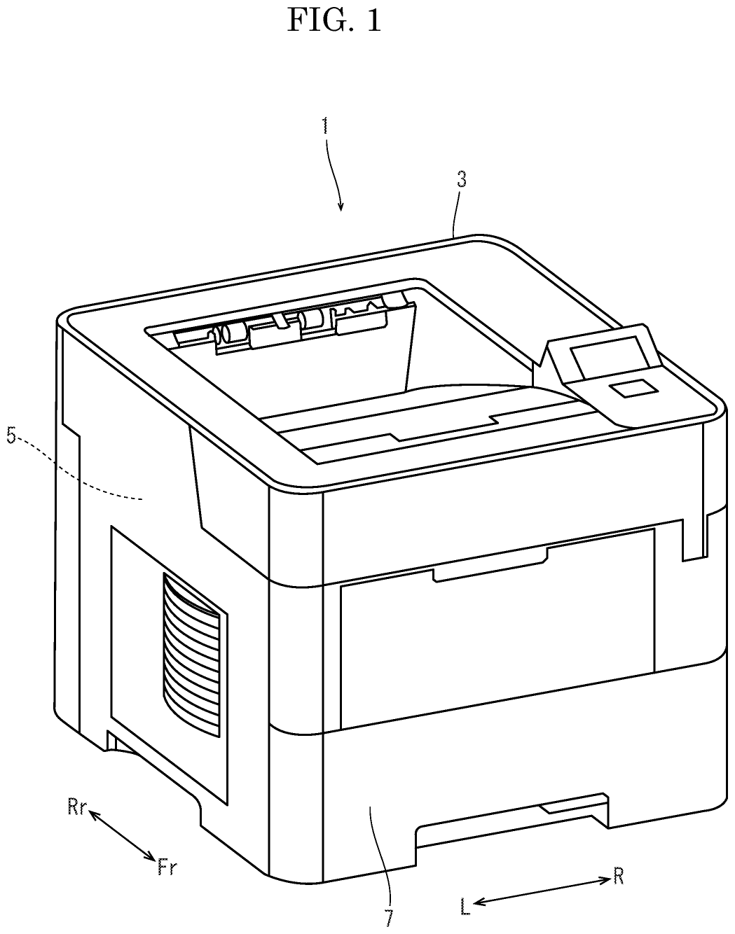

First, with reference to FIG. 1, the image forming apparatus 1 will be described. FIG. 1 is a perspective view showing the image forming apparatus 1. Fr, Rr, L and R marked in each drawing indicate the front side, the rear side, the left side and the right side of the image forming apparatus 1.

The image forming apparatus 1 includes a housing 3 having an approximately parallelepiped inside space. In the upper portion of the inside of the housing 3, an image forming part 5 which forms an image on a sheet is provided. In the lower portion of the inside of the housing 3, a sheet feeding cassette 7 in which the sheet is stored is provided. In this embodiment, the sheet feeding cassette 7 is an example of a unit.

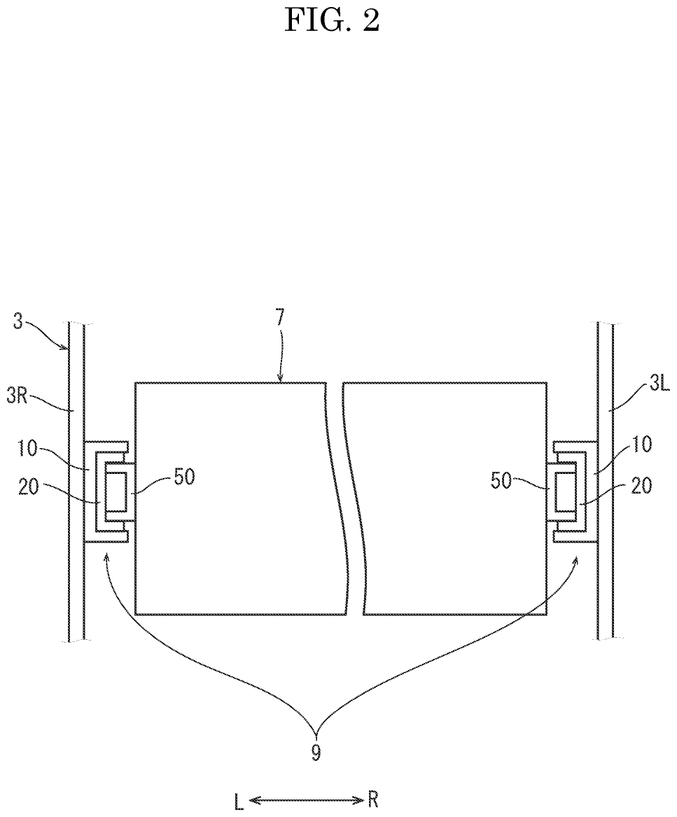

The sheet feeding cassette 7 is supported by the housing 3 with a slide rail 9 (described later with reference to FIG. 2 and the others), and is slidable in the front-and-rear direction along the horizontal plane between a storage position stored in the inside of the housing 3 and a draw-out position drawn out from the housing 3 forward. That is, in the present embodiment, a draw-out direction is a direction from the rear side to the front side, and a draw-in direction opposite to the draw-out direction is a direction from the front side to the rear side. The sheet feeding cassette 7 may be drawn out fully from the housing 3.

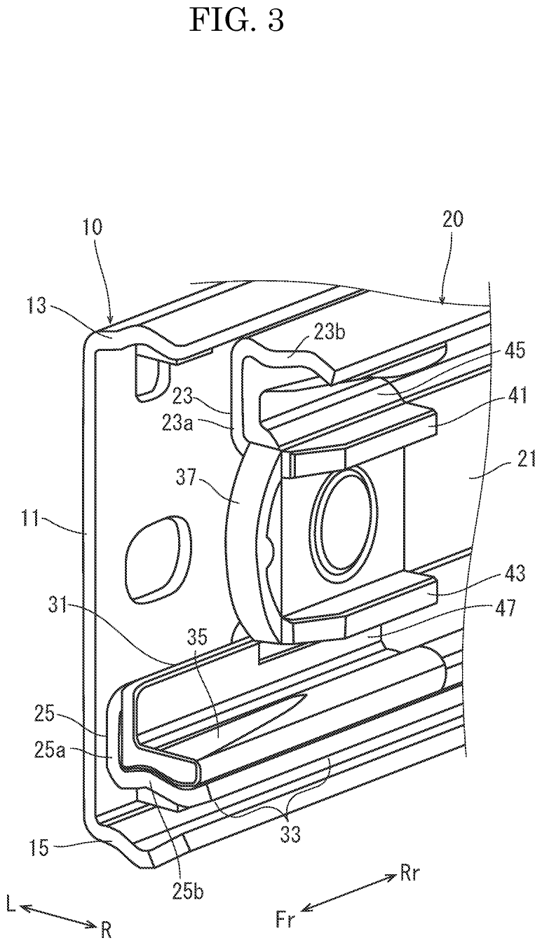

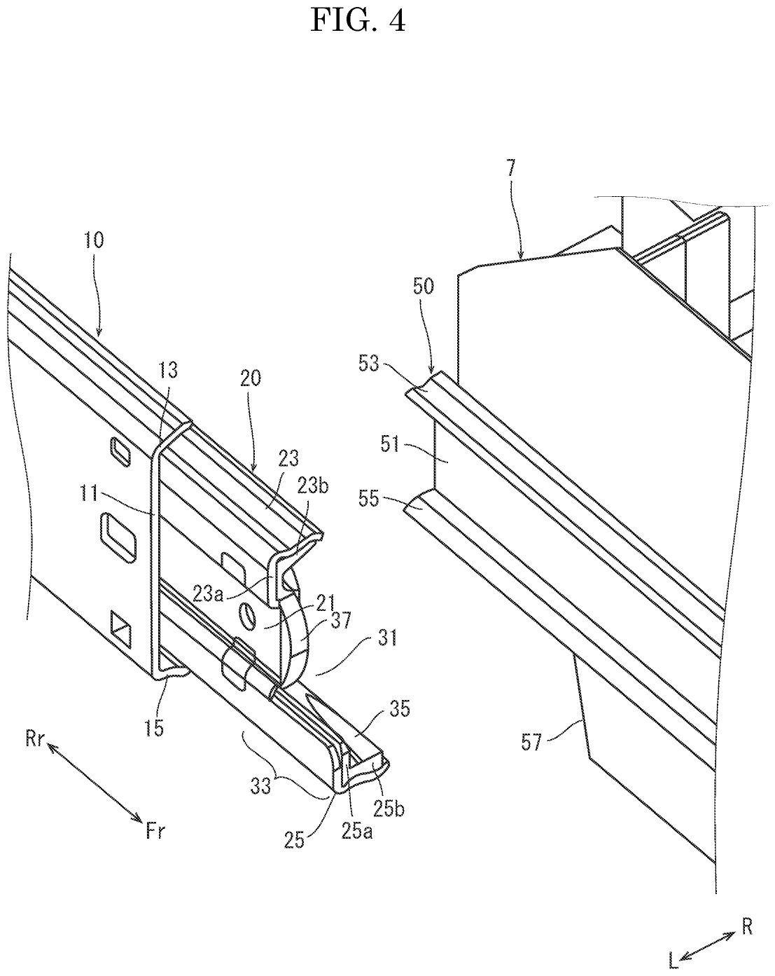

Next, with reference to FIG. 2 to FIG. 4, the slide rail 9 will be described. FIG. 2 is a front view schematically showing the slide rail 9. FIG. 3 and FIG. 4 are perspective views showing the slide rail 9.

As shown in FIG. 2, the slide rail 9 includes a pair of left and right fixed rails 10, a pair of left and right intermediate rails 20, and a pair of left and right moving rails 50. The left and the right fixed rails 10 are fixed on the left side plate 3L and the right side plate 3R of the housing 3. The left and the right intermediate rails 20 are engaged with the left and the right fixed rails 10 in a slidable manner along the left and the right fixed rails 10. The left and right moving rails 50 are fixed on the left outer surface and the right outer surface of the sheet feeding cassette 7, and engaged with the left and the right intermediate rails 20 in a slidable manner along the left and the right intermediate rails 20. Hereinafter, the left fixed rail 10, the left intermediate rail 20 and the left moving rail 50 will be described mainly. The right fixed rail 10, the right intermediate rail 20 and the right moving rail 50 have the same structures as the left fixed rail 10, the left intermediate rail 20 and the left moving rail 50.

The left and right fixed rails 10 are fixed on the inner surfaces of the left side plate 3L and the right side plate 3R of the housing 3 parallelly along the front-and-rear direction. As shown in FIG. 3 and FIG. 4, each of the left and right fixed rails 10 has a base part 11 fixed on the inner surface of the corresponding side plate, an upper edge part 13 bent from the upper end of the base part 11 to the inside of the housing 3 (to the right side in FIG. 3 and FIG. 4) substantially at right angles, and a lower edge part 15 bent from the lower end of the base part 11 to the inside of the housing 3 substantially at right angles. Each of the upper edge part 13 and the lower edge part 15 is formed such that the substantially central portion thereof in the width direction (the left-and-right direction in FIG. 3 and FIG. 4) is curved in a ridge shape. In the following description, the inside and the outside indicate the inside and the outside of the housing 3.

Each of the left and right intermediate rails 20 has a length shorter than the fixed rail 10, and is formed to have an approximately U-shaped cross section having a base part 21, an upper edge part 23 formed at the upper end of the base part 21 and a lower edge part 25 formed at the lower end of the base part 21. The upper edge part 23 has a side wall portion 23a and an upper wall portion 23b. As shown in FIG. 4, the outside surface of the side wall portion 23a is formed parallel to the outside surface of the base part 21 outside the base part 21. The upper wall portion 23b is bent from the upper end of the side wall portion 23a inwardly substantially at right angles. The lower edge part 25 has a side wall portion 25a and a lower wall portion 25b. As shown in FIG. 4, the outside surface of the side wall portion 25a is formed parallel to the outside surface of the base part 21 outside the base part 21. The lower wall portion 25b is bent from the upper end of the side wall portion 25a inwardly substantially at right angles.

Each of the upper wall portion 23b of the upper edge part 23 and the lower wall portion 25b of the lower edge part 25 is formed such that the substantially central portion thereof in the width direction (the left-and-right direction in FIG. 3 and FIG. 4) is curved in a ridge shape. By engaging the upper edge part 23 and the lower edge part 25 of the intermediate rail 20 with the upper edge part 13 and the lower edge part 15 of the fixed rail 10, the intermediate rail 20 is engaged with the fixed rail 10 in a slidable manner with respect to the fixed rail 10 in the draw-out direction and in the draw-in direction.

As shown in FIG. 3 and FIG. 4, in the rip end portion (the front end portion) of the intermediate rail 20 (the base part 21) in the draw-out direction, a notch 31 is formed. The notch 31 is formed by cutting out the upper edge part 23 and the base part 21 by a predetermined length along the draw-out direction. As a result, the lower edge part 25 extends (protrudes) in the draw-out direction by the predetermined length from the upper edge part 23 and the base part 21. Hereinafter, the extended lower edge part 25 is referred to as an extended part 33. That is, the extended part 33 is formed by the lower edge part 25 extended in the draw-out direction.

On the upper surface of the lower wall portion 25b of the extended part 33 (the lower edge part 25), an inclined surface 35 inclined downward to the draw-out direction (upward to the draw-in direction) is formed.

At the tip end portion (the front end portion) of the base part 21, a semicircular protrusion 37 protruding into the notch 31 is formed. Further, as shown in FIG. 3, on the rear side of the protrusion 37, upper and lower inner walls 41 and 43 are formed on the base part 1 parallelly along the horizontal direction. Thus, upper and lower guide grooves 45 and 47 having a predetermined length along the horizontal direction and a predetermined height are formed between the upper wall portion 23b of the upper edge part 23 and the upper inner wall 41, and between the lower wall portion 25b of the lower edge part 25 and the lower inner wall 43. The tip end surface (the front end surface) of the upper and lower inner walls 41 and 43 are inclined forward toward the base part 21.

As shown in FIG. 4, the left and right moving rails 50 are fixed parallelly on the outer surfaces of the left and right side plates of the sheet feeding cassette 7 along the front-and-rear direction. Each of the moving rails 50 has a base part 51 fixed on the outer surface of the corresponding side plate, an upper edge part 53 bent from the upper end of the base part 51 to the outside of the sheet feeding cassette 7 substantially at right angles, and a lower edge part 55 bent from the lower end of the base part 51 to the outside of the sheet feeding cassette 7 substantially at right angles. Each of the upper edge part 53 and the lower edge part 55 are formed such that the substantially central portion in the width direction (the left-and-right direction in FIG. 3 and FIG. 4) is curved in a ridge shape. By engaging the upper edge part 53 and the lower edge part 55 of the moving rail 50 with the upper edge part 23 and the lower edge part 25 of the intermediate rail 20, the moving rail 50 is engaged with the intermediate rail 20 in a slidable manner along the intermediate rail 20 in the draw-out direction and the draw-in direction.

The fixed rails 10, the intermediate rails 20 and the moving rails 50 are made of steel plate (for example, SPCC). The inclined surface 35 of the intermediate rail 20 is made of material having slidability higher than that of the intermediate rail 20 (for example, POM (polyacetal resin)). Especially, the inclined surface 35 of the intermediate rail 20 has a better sliding ability.

As shown in FIG. 4, the sheet feeding cassette 7 has a notch 57 formed in the rear lower corner below the moving rails 50.

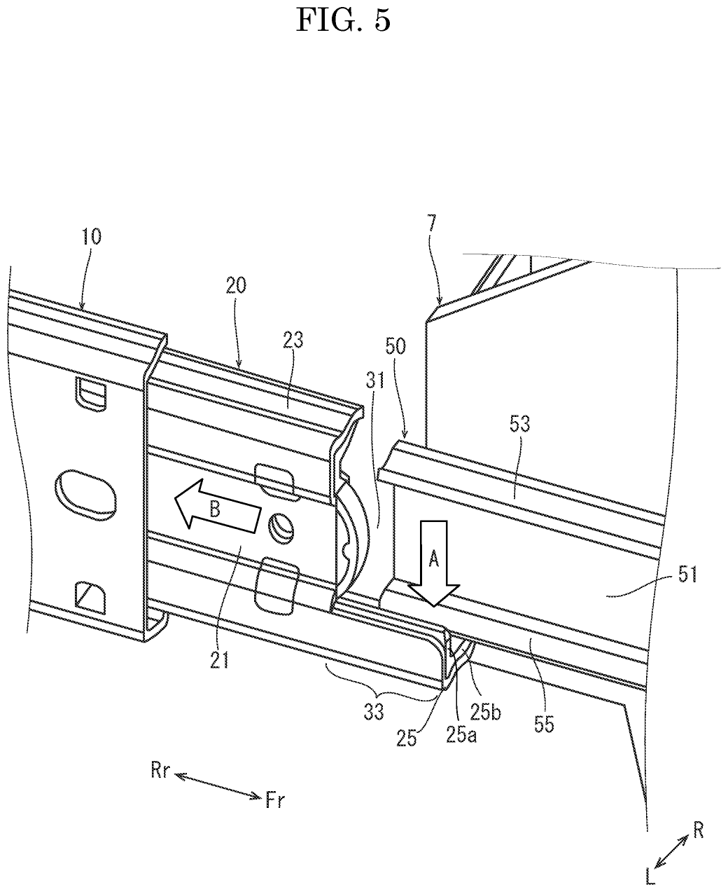

In the image forming apparatus 1 having the above configuration, a procedure for attaching the sheet feeding cassette 7 to the housing 3 will be described with reference to FIG. 5. FIG. 5 is a perspective view showing a procedure for attaching the moving rail 50 to the intermediate rail 20.

When the sheet feeding cassette 7 is attached to the housing 3, first, the intermediate rail 20 is drawn out from the fixed rail 10. Then, as shown by the arrow A in FIG. 5, the moving rail 50 of the sheet feeding cassette 7 is pressed (placed) against the extended part 33 of the intermediate rail 20 from above through the notch 31. More specifically, the lower edge part 55 of the moving rail 50 is pressed against the lower wall portion 25b of the lower edge part 25 of the intermediate rail 20. As described above, the extended part 33 is formed by cutting out the front end portion of the intermediate rail 50 such that the moving rail 50 can be pressed against the extended part 33 from above.

Thereafter, as shown by the arrow B in FIG. 5, the sheet feeding cassette 7 is fitted in with respect to the intermediate rail 20 in the draw-in direction. Then, the lower edge part 55 of the moving rail 50 is guided upward along the inclined surface 35 (see FIG. 3 and FIG. 4) of the lower edge part 25 of the intermediate rail 20, and the upper edge part 53 and the lower edge part 55 of the moving rail 50 enter between the upper edge part 23 and the lower edge part 25 of the intermediate rail 20, and more specifically, the upper and lower guide grooves 45 and 47 (see FIG. 3) of the intermediate rail 20. When the sheet feeding cassette 7 is fitted in with respect to the intermediate rail 20 in the draw-in direction, the moving rail 50 is engaged with the intermediate rail 20. Thereafter, when the sheet feeding cassette 7 is pushed in the draw-in direction, the intermediate rail 20 slides in the draw-in direction with respect to the fixed rail 10, the moving rail 50 slides in the draw-in direction with respect to the intermediate rail 20, and then the sheet feeding cassette 7 is stored in the storage position.

As described above, according to the slide rail 9 of the present disclosure, the moving rail 50 of the sheet feeding cassette 7 is placed on the intermediate rail 20 from above through the notch 31 and then is slid in the draw-in direction, so that the moving rail 50 can be easily engaged with the intermediate rail 20. That is, since it is not necessary to insert the moving rail 50 into the intermediate rail 20 from the downstream side in the draw-out direction, the attachment operation of the sheet feeding cassette 7 can be simplified.

Further, the moving rail 50 can be easily engaged with the intermediate rail 20 by sliding the moving rail 50 along the inclined surface 35 formed on the extended part 33 of the intermediate rail 20.

Although the present disclosure has been described with respect to specific embodiments, the present disclosure is not limited to the embodiments described above. Those skilled in the art will be able to modify the above embodiments without departing from the scope and spirit of the present disclosure.

1. A pair of slide rails supporting a unit on inner side surfaces of a housing in a drawable manner, each of the pair of slide rails comprising:
a fixed rail fixed on the inner side surface of the housing along a draw-in direction and a draw-out direction opposite to the draw-in direction;
an intermediate rail engaged with the fixed rail in a slidable manner along the fixed rail; and
a moving rail fixed on the unit and engaged with the intermediate rail in a slidable manner along the intermediate rail, wherein
the intermediate rail is formed to have a U-shaped cross section including a base part extending along the inner side surface of the housing and an upper edge part and a lower edge part respectively bent inward from an upper end and a lower end of the base part, and
the base part of the intermediate rail has an extended part formed in such a manner that the lower edge part is protruded from a front end portion of the base part in the draw-out direction.

2. The pair of slide rails according to claim 1, wherein
when the unit is supported on the housing, the intermediate rail is drawn out from the housing by a predetermined distance along the fixed rail, a front end portion of the moving rail in the draw-out direction is placed on an upper surface of the extended part of the intermediate rail from above, and then the moving rail is pushed in the draw-in direction along the intermediate rail while the intermediate rail is slid in the draw-in direction along the fixed rail.

3. The pair of slide rails according to claim 2, wherein
the upper surface of the extended part includes an inclined surface inclined downward to the draw-out direction, and
when the moving rail is fitted in the intermediate rail in the draw-in direction, the inclined surface guides the front end portion of the moving rail in the draw-in direction to a space between the upper edge part and the lower edge part of the intermediate rail.

4. The pair of slide rails according to claim 3, wherein
the inclined surface is made of material having slidability higher than that of the extended part.

5. The pair of slide rails according to claim 1, wherein
the extended part is formed by cutting out the upper edge part and the base part by a predetermined distance along the draw-out direction.

6. An image forming apparatus comprising:
a sheet feeding cassette in which a sheet is stored;
an image forming part which forms an image on the sheet fed from the sheet feeding cassette; and
the pair of slide rails according to claim 1, which supports the sheet feeding cassette on an apparatus main body in a drawable manner.
